(19) United States
(12) Patent Application Publication
(10) Pub. No.: US 2011/0042169 A1
(43) Pub. Date: Feb. 24, 2011

(54) LIFT WITH DUAL TRACTION PULLEY

(76) Inventor: Luciano Faletto, Milan (IT)

Correspondence Address: DILWORTH & BARRESE, LLP, 1000 WOODBURY ROAD, SUITE 405, WOODBURY, NY, 11797, US

(21) Appl. No.: 12/521,431

(22) PCT Filed: Dec. 24, 2007
(86) PCT No.: PCT/IB07/04504

§ 371 Date: Nov. 8, 2010

(30) Foreign Application Priority Data
Dec. 29, 2006 (IT) MI2006A002542

(51) Int. Cl. B66B 11/04

(52) U.S. Cl. 187/256

(57) ABSTRACT

The present invention relates to systems for maximizing the cage (4) size in lift plants by a traction machine (3) each provided with two traction pulleys (1, 2) equal in size to the half of a common pulley, on which the suspension pulleys (11, 14) are wrapped divided into two groups, each of them developing a suspension size ratio equal to 1:2 or greater, either for the cage (4) or the counterweight (5).

The present invention relates to systems for maximizing the cage size in lift plants by a traction machine provided with two traction pulleys, each having about half size in respect of a common pulley, on which the suspension ropes are wrapped divided into two groups, each of these realizes a ratio suspension equal to 1:2 or greater, either for the cage or the counterweight.

Herein the size ratio is defined by a notation referring to ratio between the speed of the mass to be moved and the speed of the suspension elongated element, therefore 1:2, 1:4, 1:6, etc.

In other documents other notations can be adopted, defining instead ratio between the weight of the mass to be moved and the traction load on the suspension element, therefore 2:1, 4:1, 6:1, etc.

In the following disclosure flat belts, grooved belts, circular section ropes will be indifferently mentioned, such as possible examples of suspension elongated elements. An expedient useful to make the lift building cheaper and more efficient consists in compacting to the maximum all the auxiliary apparatuses to be installed in the lift shaft, even though lifts without machine room are built, in order to maximize the cage size, in a lift shaft limited in size, allowing all the users a better accessibility.

In order to obtain such a result different elements can be specifically modified which, on plan, are really considerable bulks in the lift shaft, bulks such that they limit the maximum size achievable for the cage. The modifications in these terms cannot leave outside the consideration the fact that in a lift there are parts having bulky dimensions pretty considerable and therefore requiring minimum spaces, between the cage and the lift shaft walls, to be realized in which other essential parts can be housed, such that free spaces are optimized and the overall dimensions of the lift shaft under the same cage size are reduced.

The first operation consists in trying to reduce the size of the basic parts, in order to minimize the dimensions of free spaces not completely used. There have been provided solutions which allow, increasing the size ratio for the cage lifting, for using a lower number of ropes and therefore suspension and deflecting pulleys with a contained thickness, as well as driving motors with even more reduced driving torque thus smaller in size. By the inventive solution hereinafter disclosed the free space use existing in the lift shaft are intended to be optimized, by the use of doubled parts having dimensions reduced in respect of the parts necessary into similar solutions without doubled parts.

It is particularly provided to build a lift without the machine room, in which a traction machine is adopted provided with two traction pulleys, each having almost half size in respect of the common pulley and diameter even smaller than 300 mm, on which the suspension ropes are wrapped divided into two groups, each of these realize a suspension ratio equal to 1:2 or greater, either for the cage or the counterweight. The thickness dimensions of the suspension and deflecting pulleys are almost half in respect of the pulleys necessary for a similar conventional ratio suspension. Therefore in the lift shaft the crossing bulk dimensions of the apparatuses, used according to the innovative proposal disclosed, are more contained and allow advantageously for realizing, under the same lift shaft size, a cage bigger in size. Alternatively, under the same cage dimensions, smaller dimensions of the lift shaft are enough to contain advantageously all the lift apparatuses.

Moreover, the innovative solution proposed allows for placing advantageously the deflecting pulleys to be installed on the top of the lift shaft, on the cage side, onto the two sides of the cage guide placed on the side opposite to the counterweight. It allows for using the space between the lift shaft wall and the cage wall, necessary for placing the cage guide, in order completely or in large part the bulk of the suspension pulleys, realizing advantageously a restraint of the lift shaft dimensions and a substantially centric cage suspension in respect of the center of gravity of the same and the position of the corresponding guide plane. The absence of bulks of apparatuses over the cage allows further for extending the lift run up to the upper end of the lift shaft, containing also the overall height of the head between the extreme floor plane and the lift shaft cover.

The doubling of the cage suspension pulleys allows a better load distribution and therefore a mass reduction of the cage, and then it is also possible to reduce the mass and size of the counterweight, in favour of the possible dimensions of the cage, under the same lift shaft. This implies the need to increase friction between ropes and pulleys. This further problem can be solved by suitable expedients regarding dowelling, with improved friction material, of the races of the pulleys that will be illustrated later. The feature of the invention previously disclosed can be found in the following description, in some of the possible advantageous configurations. Embodiments not limiting of the present invention are shown in the annexed drawings. In detail:

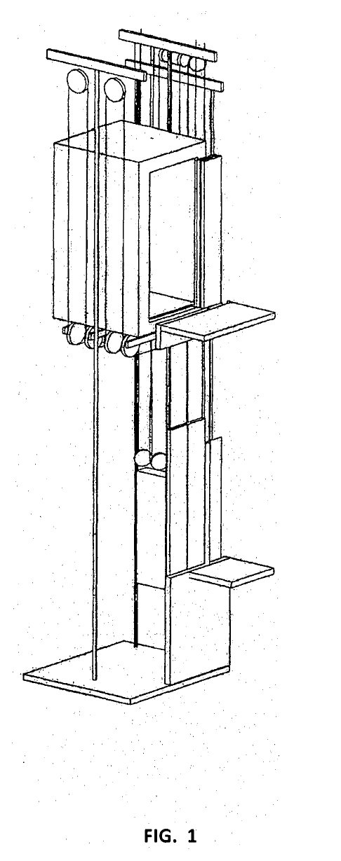

FIG. 1 is a top front lateral perspective view of a version of the lift object of the invention with suspension ratio equal to 1:4.

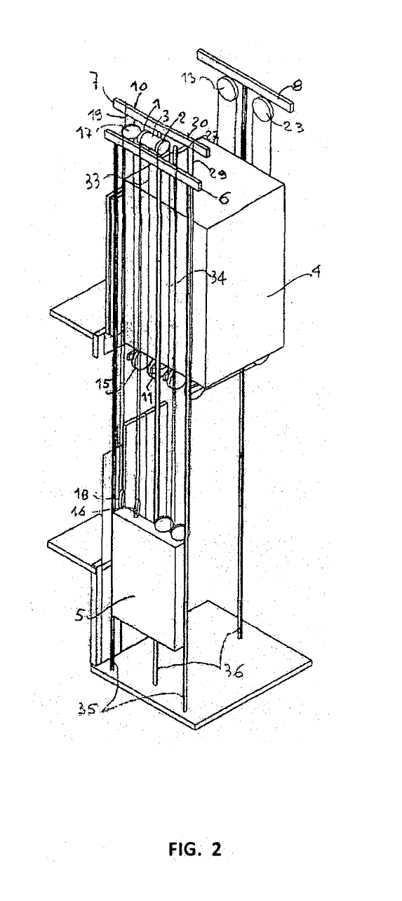

FIG. 2 is a rear lateral perspective view of the lift shown in FIG. 1.

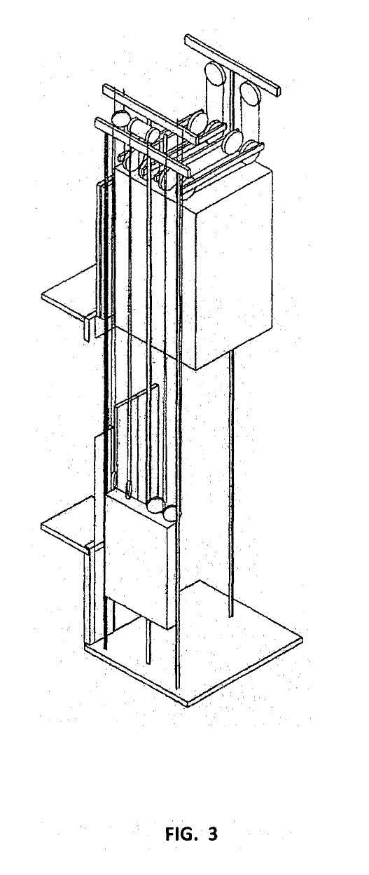

FIG. 3 is a group perspective view of another version of the lift according to the invention in an embodiment with suspension equal to 1:4 and cage suspension pulleys placed on the roof of the same. This solution allows for obtaining a very reduced hollow depth.

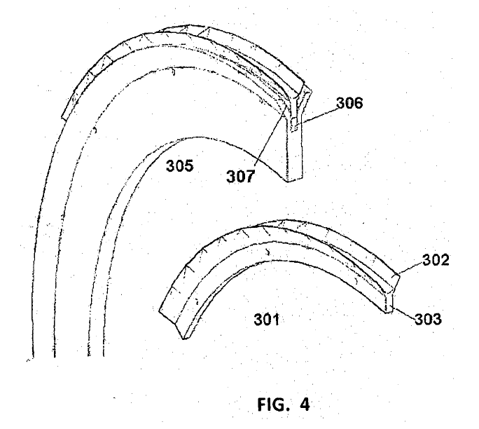

FIG. 4 is a perspective view of the race dowelling of the pulley and the shape of the housing groove object of the invention.

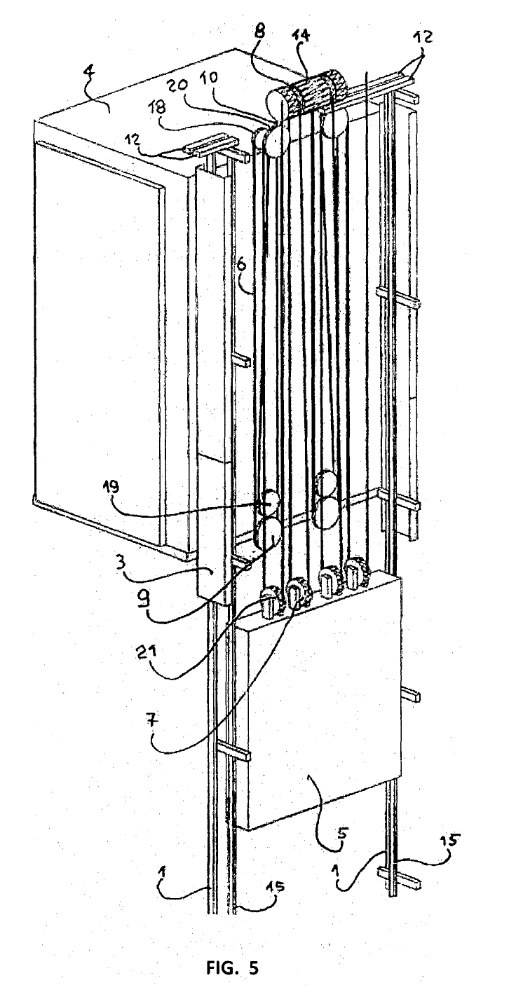

FIG. 5 is a group view of a solution for the lift according to the invention having suspension equal to 1:4.

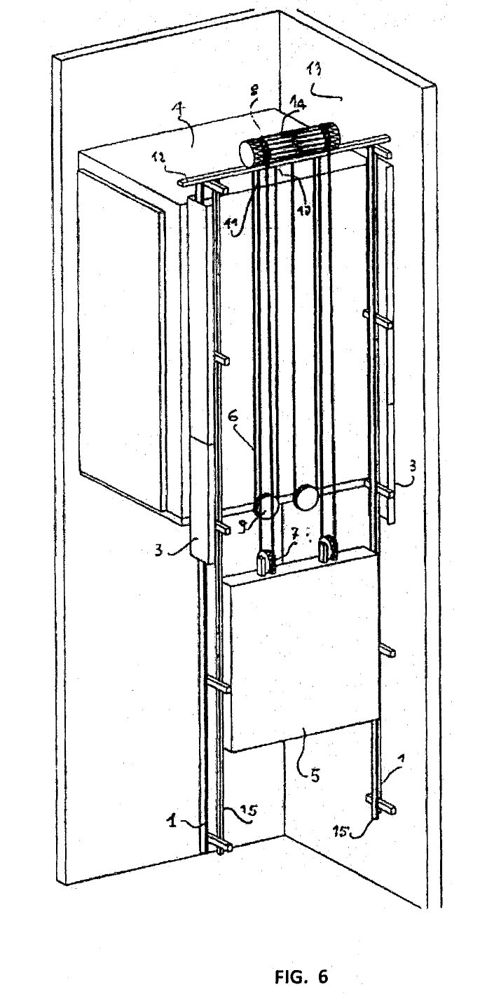

FIG. 6 is a group view of a solution for the lift according to the invention having Rucksack suspension equal to 1:2.

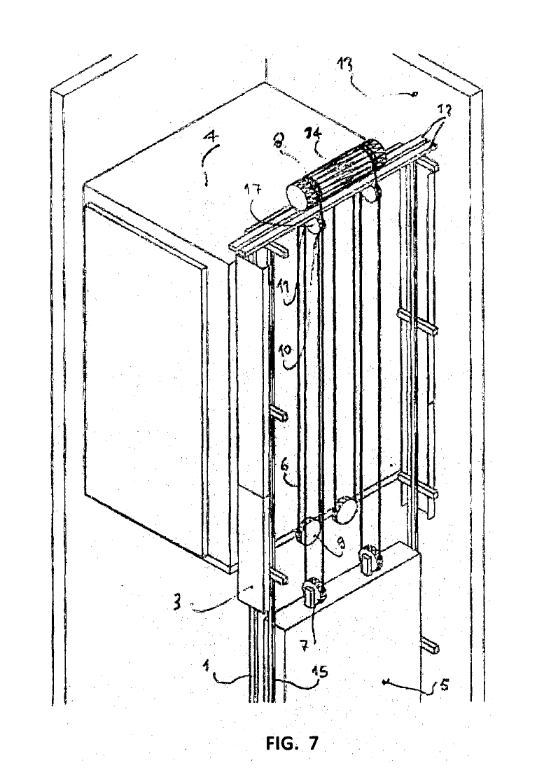

FIG. 7 is a group view of a further solution for the lift according to the invention having Rucksack suspension equal to 1:2.

The path of the ropes showed as follows, is described as illustrative and not limiting and refers to one of the multiple solutions achievable using the object of the invention. With reference to FIGS. 1 and 2, there is described an invention relating to a lift with suspension equal to 1:4, without machine room, called MRL (Machine Room Less), in which the counterweight 5 runs along the guides 35, beside the cage 4, running along the guides 36. In the shown solution the motor 3 placed on the top of the vertical of the counterweight 5 and supported by a supporting crossbar 6, is provided with two pulleys 1 and 2 placed on the two opposite sides of the drive shaft opposite in respect of the framework of the same motor, placed towards the counterweight side. The ropes are divided into two groups each having at least one rope. In the description we refer to only one rope for each group, rope 33 and rope 34, in which any additional rope of each group runs along a similar path. The rope 33 has one of the ends fixed to the connection 19 placed onto the supporting crossbar 7 within the lift hollow upright the counterweight. The rope path is described as follows, and due to the symmetry of the problem only the path of the rope 33 will be described. Starting from the connection 19, the rope 33 goes down towards the counterweight 5, where it is wrapped around the counterweight suspension pulley 18, then returning upwards, where it crosses a deflecting pulley 17 which sends it back to a counterweight suspension pulley 16, around which it is wrapped before returning upwards thus crossing the traction pulley 1 of the machine 3, on its pertaining side. The rope 33 then passes under the cage and over the pair of suspension pulleys 11 and 12 (pulley 12 symmetric in respect of the pulley 11 and not shown in figure), then being wrapped around the deflecting pulley 13 placed on the top beside the cage guide 36, on the side opposite to the counterweight. The deflecting pulley 13 is at least in part contained by the bulk given by cage guide, placed between the cage wall and the adjacent lift shaft wall. From the deflecting pulley 13 the rope 33 returns downwards to the cage bottom and passes again under the same, through another pair of suspension pulleys 14 and 15 (pulley 14 symmetric in respect of the pulley 15 and not shown in figure), thus going upwards and having the end fixed to the upper connection 10 onto the crossbar 7. The path of the rope 34 is similar and symmetric in respect of what seen about the rope 33. On the counterweight side the counterweight suspension pulleys 16 and 18 and the deflecting 17 have the rotation plan inclined in respect of the adjacent walls of the cage and the lift shaft, so as to reduce the cross bulk and distributing the ratio pulleys along the width of the counterweight. Similarly for the corresponding pulleys involved in the path of the rope 34. The advantage of such solution, for which it is provided that traction pulleys with races provided with removable improved friction covering dowels may be used, is to reduce cross bulks of the ratio pulleys and ropes, by the expedient of dividing the ropes into two groups. Such expedient allows also for placing the cage side deflecting pulleys 13 and 23 at the two sides of the guide 30, so as to further reduce the space required into the lift shaft for the rope passing, never interfering with the same guide.

Referring now to FIG. 4 there are shown a dowelling arc 301 of a multi-race pulley 305, of which herein only a race is illustrated, sectioned and with the dowelling arc 301 inserted in the circular race 307 with undercut 306. The same dowelling further provides a section with side wings 302, aim of which is to provide a protection and lateral guide for the rope. The possibility to manufacture the pulley dowelling by dowelling arcs 301 separable one from another allows an easier replacement by segments, by rotating the pulley on which they are mounted around an arc suitable for the replacement, without disassembling the ropes in order to replace the whole circular dowel. This represents an important advantage in terms of comfort and cost, considering the stop time and therefore the dowelling maintenance. In order to allow an easy replacement of the dowels, they must be at least three for each pulley race. Once worn by friction the filleted bottom of the dowel where preferably the rope abuts, this comes in contact with the race metallic surface, but in part rests abutted onto the dowel tang inserted in the undercut 306, which assures enough friction for moving during short periods, because of the excessive consumption of the ropes under these conditions.

Even referring to FIG. 4, the function of the undercut 306 either to provide a mounting system and holding in place for the dowelling arcs 301, or, in case of their wear, to assure a certain friction between the undercut 306 and the metallic ropes so as to allow for moving the lift during a short period, though not assuring a rope life comparable to the one in presence of dowelling, due to their wear when in contact with the undercut 306.

Other innovative solutions based on the two separate traction pulley machine are hereinafter illustrated and they refer to a lift with suspension commonly called Rucksack, in which the cage guides are placed on only one side of the cage, side on which the counterweight is also housed. Another embodiment of the innovative solution illustrated provides again the use of a cage 4 with a Rucksack suspension and size ratio equal to 1:4, in which the cage suspension pulleys are placed in the lower part of the same, at each descent of the ropes coming from the two traction pulleys.

FIG. 5 is a group view of a lift solution according to the invention, having 1:4 suspension, cage guides on the counterweight side and with two pairs of cage suspension pulleys placed in the lower part of the cage wall on the side where the counterweight stands. The split and stagger of the cage suspension pulleys contributes in reducing the cross bulks. A particular configuration of such application, illustrated in FIG. 7, consists in displacing each pair of the cage suspension pulleys 9 and 19 with rotation planes almost parallel one in respect of the other and the wall plane adjacent to the cage. Each pair of pulleys 9 and 19 is placed beside the cage wall and the solution illustrated in FIG. 7 shows them overlapped. At the upper crossbars 12 supporting the machinery, placed on the top of the lift shaft, outside the cage projection, the deflecting pulleys 18 are displaced for the descent of the cage side suspension ropes and the ropes 20 for the descent of the counterweight side ropes. The counterweight is provided with two pairs of suspension pulleys 7 to 12. The rope path is doubled and there is simply described only one path track, as illustrated in FIG. 7. In FIG. 5 there is pointed out a lift in which the cage 4 supported by a structure 3 slides vertically along the guide 1, connected to a counterweight 5 by an elongated connection element 6 fixed at its ends to connection point 10, at the cage side, and 11, at the counterweight side. The counterweight slides vertically along the guides 15. The cage suspension and the counterweight suspension are equal to 1:4, with the elongated connection element 6 staring form the cage side connection point 10, falling vertically towards the suspension pulley 19 placed in the lower part of the cage supporting structure, being wrapped around the pulley 19, rising almost vertically towards the deflecting pulley 18 connected to the supporting structure 12 of the machinery, being wrapped around the pulley 18, falling again vertically towards the suspension pulley 9 placed in the lower part of the cage supporting structure, being wrapped around the pulley 9, rising almost vertically towards the traction pulley 8 placed in the upper part of the lift shaft, being wrapped around the same then falling again towards the counterweight suspension pulley 7, being wrapped around the same and restarting upwards along the direction of the deflecting pulley 20 connected to the supporting structure 12 of the machinery, being wrapped around the pulley 20, falling again vertically towards the counterweight suspension pulley 21, being wrapped around the same and returning upwards for being fixed to the support 11, placed on the upper supporting structure 12, which leans on the guides and is fixed to the top of the lift shaft 13. The pulley 8 is a part of the lifting machine 14, placed over the top of the lift shaft 13, and supported by the upper supporting structure 12.

FIG. 6 is a group view of a solution of the lift according to the invention, having the Rucksack 1:2 suspension, cage guides on the counterweight side and with cage suspension pulleys placed at the bottom of the cage wall on the side where the counterweight stands. The splitting of the cage suspension pulleys contributes to reduce the cross bulks.

FIG. 7 is a group view of a further solution of the lift according to the invention, having Rucksack 1:2 suspension, suspension pulleys of the cage and the counterweight such as in the solution of FIG. 7 and traction type DW (Double Wrap). FIG. 6 shows one of the embodiments of such solution, which provides a size ratio equal to 1:2, in which the cage suspension pulleys are placed at the lower portion of the same, with the rotation plane almost parallel to the adjacent cage wall, a pulley for each rope or rope group coming from each of the traction pulleys. The halving of the rope number of each group allows for decreasing the thickness of the cage suspension pulleys, thus reducing the on plan overall dimensions of the spaces not allowable for carrying out the same cage. In FIG. 6 is pointed out a lift in which the cage 4 supported by a structure 3 slides vertically along the guides 1, connected to a counterweight 5 by a connection elongated element 6 fixed at its ends to the connection points 10, on the cage side, and 11, on the counterweight side. The counterweight slides vertically along the guides 15. The suspension of the cage and the counterweight is equal to 1:2, with the connection elongated element 6 starting from the cage side connection point 10, falling down vertically towards the suspension pulley 9 placed in the lower portion of the cage supporting structure, being wrapped around the pulley 9, rising almost vertically towards the traction pulley 8 placed in the top of the lift shaft, being wrapped around the same then falling again downwards the counterweight suspension pulley 7, being wrapped around the same and returning upwards in order to be fixed to the support 11, placed on the upper supporting structure 12, which leans on the guides and is fixed to the top of the lift shaft 13. The pulley 8 is part of the lifting machine 14, placed over the top of the lift shaft 13, and supported by the upper supporting structure 12.

In FIG. 7 there is shown another version of the lift of the same type illustrated in FIG. 6, in the case in which the friction between the connection elongated element 6 and the traction pulley 8 is not enough to assure the right driving of the cage in all the load conditions. In such case can be adopted, indeed, advantageously the double wrap solution (DW), in which to the traction pulley 8 a deflecting pulley 16 is added, placed under the same and slightly shifted towards the cage side or the counterweight. In the case shown in FIG. 6 the pulley is shifted to the counterweight side, such that the path of the connection elongated element 6 is expanding as disclosed for the case in FIG. 7, except the track between the pulley 8, pulley 7 and the connection point 11, which is modified as follows: the elongated element 6, once wrapped around the pulley 8, is wrapped around the pulley 16, returns towards the pulley 8, is wrapped around it and passes again onto the pulley 16 from which it moves downwards the counterweight suspension pulley 7. The suspension elongated element, once wrapped around the pulley 7 rising almost vertically in order to be fixed to the support 12, in the connection point 11. The lift object of the invention can advantageously present other features object of further embodiments. These are herein schematically listed as exemplificative and not limiting:
cage suspension ratio equal to 1:5
cage suspension ratio equal to 1:6
as mentioned, the cage suspension elongated element can be ropes, flat belts or grooved belt
the position of the cage suspension pulleys can be over the cage top, rather than under the bottom
the cage suspension pulleys with 1:4 Rucksack archway can be placed with rotation planes parallel or inclined or perpendicular one in respect of the other
the two traction pulleys for lifts with Rucksack archway can be brought nearer one to the other and placed at the central portion of the lifting machine
the guide of the cage and counterweight of the lift with Rucksack archway can be displaced on the same side if the connection elements to the structure of the lift shaft
the counterweight suspension of the lifts with Rucksack archway can be made by one or more pulleys having the rotation plane parallel to the guide plane, or inclined or perpendicular in respect of the guide plane.

1. A lift without machine room (MRL, Machine Room Less) suitable for buildings comprising a traction machine, placed inside the lift shaft with a double traction pulley, the traction pulleys are small in size, with a first traction pulley (1) and a second traction pulley (2) placed in the space between the cage wall and the adjacent wall of the lift shaft and with a configuration of suspension pulleys and elongated suspension elements in the lift shaft to obtain a suspension of the cage (4) and a counterweight (5) at least 1:4 in ratio.

2. The lift according to claim 1 wherein the suspension pulleys of the counterweight (5) and the deflecting pulleys next to a motor have a rotation plane inclined in respect of the adjacent walls of the cage (4) and of the lift shaft, to reduce the cross bulks and to split the ratio size pulleys along the counterweight width, and are placed in the space between the cage wall and the adjacent wall of the lift shaft.

3. The lift according to claim 1 wherein the suspension ratio is 1:5.

4. The lift according to claim 1 wherein the suspension ratio is 1:6.

5. The lift according to claim 1 wherein the suspension pulleys of the cage (4) are placed on the top of the cage (4).

6. The lift according to claim 1 wherein the suspension elongated elements are ropes.

7. The lift according to claim 1 wherein the suspension elongated elements are flat belts.

8. The lift according to claim 1 wherein the suspension elongated elements are grooved belts.

9. (canceled)

10. The lift according to claim 1, comprising the counterweight (5) on the side of the cage (4), in which a motor (3), placed at the top upright the counterweight (5) and supported by a supporting crossbar (6), is provided with the first traction pulley (1) and the second traction pulley (2) placed on opposite sides of the driving shaft (3); and wherein the suspension elongated elements are divided into two groups each having at least one suspension elongated element, a group for the first pulley (1) and a group for the second pulley (2), with one suspension elongated element (33) of the first group and one suspension elongated element (34) of the second group; the suspension elongated element (33) having one of the ends fixed to a joint (19), placed on a supporting crossbar (7) placed at the top, into the lift shaft, over the counterweight (5); starting from the joint (19) the suspension elongated element (33), going down towards the counterweight (5), where it is wrapped around a counterweight suspension pulley (18), then returning upwards, where it crosses a deflecting pulley (17) placed next to the supporting crossbar (6) which resends to a suspension pulley (16) of the counterweight (5), around which it is wrapped in order to return upwards and to cross the traction pulley (1) of the motor (3); the suspension elongated element (33) then passes on a pair of suspension pulleys (11, 12) placed under the cage, the pulleys (11, 12) symmetric in respect of the cage entry door; the suspension elongated element (33) is then wrapped around the deflecting pulley (13) placed at the top beside a cage guide (36), on the opposite side of the counterweight (5), in the space between the cage wall and the lift shaft wall; from the deflecting pulley (13) the suspension elongated element (33) returns towards the cage bottom and passes again under the same, through a second pair of suspension pulleys (14) and (15) placed under the cage (4), the suspension pulleys (14, 15) symmetric in respect of the cage entry door, then going upwards and having the end fixed on an upper joint (10) on the crossbar (7); for the suspension elongated element (34) the path is similar and symmetric in respect of the path about the suspension elongated element (33).

11. A lift without machine room (MRL, Machine Room Less) suitable for buildings with Rucksack cage suspension, cage guide displacement on the same side of the counterweight, a traction machine, placed at the top inside the lift shaft, with a double traction pulley small in size, with a first traction pulley (1) and a second traction pulley (2) placed in the space between the cage wall and the adjacent wall of the lift shaft and comprising a configuration of the suspension pulleys and suspension elongated element in the lift shaft to obtain two groups of suspension elements of a cage (4) and a counterweight (5) at least 1:4 in size ratio.

12. The lift according to claim 11 wherein the suspension pulleys of the cage (4) are placed at the lower portion of the cage, in the space between the cage wall and the adjacent counterweight wall, and have a rotation plane placed to distribute the size ratio pulleys along the width of the cage and to reduce the cross bulks.

13. The lift according to claim 11 wherein the suspension pulleys of the counterweight (5) and the deflecting pulleys next to a motor are contained in the space between the cage wall and the adjacent wall of the lift shaft and are displaced to distribute the size ratio pulleys along the width of the counterweight and to reduce the cross bulks.

14. A lift without machine room (MRL, Machine Room Less) suitable for buildings with Rucksack cage suspension, cage guide displacement on the same side of the counterweight, a traction machine, placed at the top inside the lift shaft, with a double traction pulley small in size, with a first traction pulley (1) and a second traction pulley (2) placed in the space between the cage wall and the adjacent wall of the lift shaft and a configuration of the suspension pulleys and suspension elongated elements in the lift shaft with a size ratio equal to 1:2, wherein it has two different groups of suspension elements of a cage (4), displaced on the cage side towards the counterweight, having a small cross bulk.

15. The lift without machine room (MRL, Machine Room Less) according to claim 11, wherein the traction of the suspension elongated elements is obtained by a double wrap system (DW, Double Wrap).

16. (canceled)

17. The lift according to claim 2 wherein the suspension ratio is 1:5.

18. The lift according to claim 2 wherein the suspension ratio is 1:6.

19. The lift according to claim 18 wherein the suspension pulleys of the cage (4) are placed on the top of the cage (4).

20. The lift according to claim 17 wherein the suspension pulleys of the cage (4) are placed on the top of the cage (4).

21. The lift according to claim 4 wherein the suspension pulleys of the cage (4) are placed on the top of the cage (4).

22. The lift according to claim 3 wherein the suspension pulleys of the cage (4) are placed on the top of the cage (4).
